(19) United States
(12) Patent Application Publication
(10) Pub. No.: US 2004/0080488 A1
(43) Pub. Date: Apr. 29, 2004

(54) Method of and apparatus for inputting character using pointing device

(75) Inventors: Jin-mook Lim, Daejeon (KR); Sang-goog Lee, Anyang-city (KR); Byung-seok Soh, Suwon-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/455,434

(22) Filed: Jun. 6, 2003

(30) Foreign Application Priority Data
Oct. 26, 2002 (KR) 2002-65660

(51) Int. Cl. G09G 5/00

(52) U.S. Cl. 345/156

(57) ABSTRACT

A method of inputting a character using a pointing device and an apparatus for inputting the character are provided. The method includes recognizing information on a movement direction of the pointing device and a click information of a button of the pointing device, and selecting a character by using the recognized information on a movement direction of the pointing device and the click information of the button of the pointing device. The character can be inputted via a mouse movement direction and the mouse button click information. In addition, since only one hand is used to input the character, a user can perform other tasks while inputting a character.

### BACKGROUND OF THE INVENTION

This application claims the priority of Korean Patent Application No. 2002-65660 filed on Oct. 26, 2002, in the Korean Intellectual Property Office, the disclosure of which is incorporated herein in its entirety by reference.

1. Field of the Invention

The present invention relates to a method of and an apparatus for inputting characters, and more particularly, to a method of inputting characters using a pointing device and an apparatus using the method.

2. Description of the Related Art

In line with recent computer advancements, there have been various studies and developments concerning an apparatus for inputting characters which uses the hands and arms for typing. FIG. 1 shows a keyboard developed by Keybowl, Inc., which is currently used as an alternative to traditional keyboards.

Keybowl 100 is a keyless keyboard comprised of two domes 110 and 120 upon which the hands of a user rest comfortably. Each dome slides into one of eight positions, e.g., a compass arrangement N., NE., E., SE., S., SW., W., NW., from a central resting point. Each dome is capable of sliding into the same eight compass directions, and thus a total number of 64 characters can be selected. The user can select characters by resting the hands upon the two domes and then sliding the domes into desired directions without any additional operations. However, this keyless keyboard is bulky and not appropriate for use as a portable input device. In addition, it requires relatively sizable movements of the hands, wrists, and arms, and it can not be used to input characters unless it firmly lies on a stable surface.

### SUMMARY OF THE INVENTION

It is an object of the present invention to provide a method of conveniently and easily inputting characters by using a conventional pointing device, and an apparatus for inputting characters using the method.

According to one aspect of the present invention, there is provided a method of inputting a character using a pointing device, the method comprising (a) recognizing information on a movement of the pointing device and a click information of a button of the pointing device, and (b) selecting a character by using the recognized information on a movement of the pointing device and click information of the button of the pointing device.

According to another aspect of the present invention, there is provided an apparatus for inputting a character using a pointing device, the apparatus comprising a character input table which stores combinations of information on movements of the pointing device and button click information of a button of the pointing device and maps the combinations to characters to be inputted, a movement recognizing unit which recognizes the information on the movements of the pointing device and the button click information of the button of the pointing device, a status storage unit which stores the information on the movements of the pointing device and the button click information, as recognized by the movement recognizing unit, and a character selecting unit which selects a character that corresponds to the information on the movements of the pointing device and the button click information which are stored in the status storage unit, by referring to the character input table.

### BRIEF DESCRIPTION OF THE DRAWINGS

The above objects and advantages of the present invention will become more apparent by describing in detail exemplary embodiments thereof with reference to the attached drawings in which:

FIG. 1 is a view of an apparatus for inputting characters by using a bowl click, according to the conventional art;

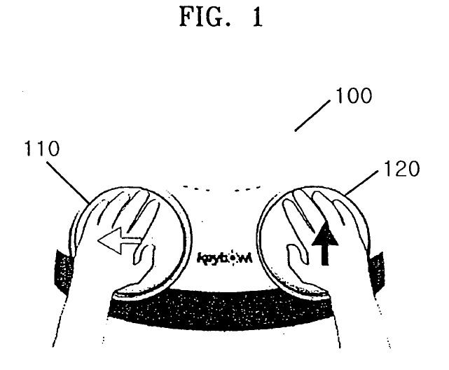

FIG. 2 is a block diagram of a configuration of an apparatus for inputting characters according to an embodiment of the present invention;

FIG. 3 is a view for describing a method of inputting characters according to an embodiment of the present invention, in particular, when an English character input mode is selected, a left mouse button is clicked and the left mouse button is pressed while moving the mouse;

FIG. 4 is a view for describing a method of inputting characters according to another embodiment of the present invention, in particular, when an English character input mode is selected, a right mouse button is clicked and the right mouse button is pressed while moving the mouse;

FIG. 5 is a view for describing a method of inputting characters according to another embodiment of the present invention, in particular, when a Korean character input mode is selected, a left mouse button is clicked and the left mouse button is pressed while moving the mouse;

FIG. 6 is a view for describing a method of inputting characters according to another embodiment of the present invention, in particular, when a Korean character input mode is selected, a right mouse button is clicked and the right mouse button is pressed while moving the mouse;

FIG. 7 is a view for describing a method of inputting characters according to another embodiment of the present invention, in particular, when a number key and other character input mode is selected, a left mouse button is clicked and the left mouse button is pressed while moving the mouse;

FIG. 8 is a view for describing a method of inputting characters according to another embodiment of the present invention, in particular, when a number key and other character input mode is selected, right mouse button is clicked and the right mouse button is pressed while moving the mouse;

FIG. 9 is a flowchart for explaining a method of inputting characters according to an embodiment of the present invention;

FIG. 10 is a flowchart for explaining the steps for storing character input modes in the method described with reference to FIG. 9;

FIG. 11A is a view for explaining a method of selecting a character input mode according to an embodiment of the present invention;

FIG. 11B is a view for explaining a second embodiment of a method of selecting a character input mode according to an embodiment of the present invention;

FIG. 11C is a view for explaining a third embodiment of a method of selecting a character input mode according to an embodiment of the present invention;

FIG. 12 is a flowchart for explaining the step for storing numbers by clicking the mouse button of FIG. 9;

FIG. 13 is a flowchart for explaining the step for storing directions by dragging the mouse of FIG. 9;

FIG. 14 is a flowchart for explaining the step for storing the mouse button used in dragging of FIG. 9;

FIGS. 15A and 15B show a character input table for an English character input mode presented with respect to FIG. 2 according to an embodiment of the present invention;

FIGS. 16A and 16B show a character input table for a Korean character input mode presented with respect to FIG. 2 according to an embodiment of the present invention;

FIGS. 17A and 17B show a character input table for a number and other character input mode presented with respect to FIG. 2 according to an embodiment of the present invention; and

FIG. 18 is a view for describing a method of inputting characters according to an embodiment of the present invention.

### DETAILED DESCRIPTION OF THE INVENTION

The present invention will now be described more fully with reference to the accompanying drawings, in which illustrative, non-limiting embodiments of the invention are shown.

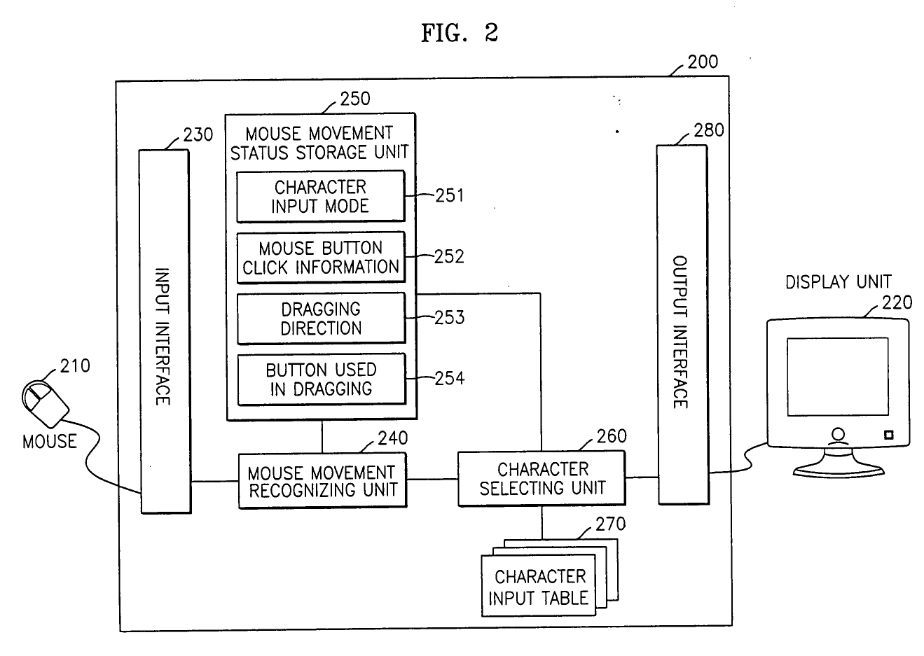

FIG. 2 shows a configuration of an apparatus for inputting characters according to an embodiment of the present invention.

An apparatus for inputting characters 200 includes an input interface 230, a mouse movement recognizing unit 240, a mouse movement status storage unit 250, a desired character selecting unit 260, a character input table 270, and an output interface 280. The apparatus for inputting characters 200 also includes a processor, a memory, and a register, all of which are not shown inside the main body of a computer. However, FIG. 2 focuses on the configuration for inputting characters.

The input interface 230 transmits data between a mouse 210 and the apparatus for inputting characters 200. The output interface 280 transmits data between the apparatus for inputting characters 200 and a display unit 220.

The mouse movement recognizing unit 240 receives the mouse movements performed by a user through the input interface 230 and recognizes the mouse movements. Information on the mouse movements includes a mouse direction, a mouse button information on the mouse button which is used in the mouse movement, a mouse button click information on the mouse button clicked during the mouse movement, a mouse button double click information on the mouse button double clicked during the mouse movement, or the like. Here, the mouse direction can be determined by comparing a unit vector with a vector determined from the angular coordinates displayed when the mouse button is pressed and when the mouse button is released.

The information on the movements, which is determined by the mouse movement recognizing unit 240, is stored in a mouse movement status storage unit 250. The mouse movement status storage unit 250 can include a status flag 251 which stores a character input mode, a status flag 252 which stores information on a mouse button that is clicked, a status flag 253 which stores the direction in which the mouse is moved, and a status flag 254 which stores information on a mouse button held while the mouse is moved. Here, information on the character input mode stored in the status flag 251 is provided by displaying predetermined menus on the display unit 220 and selecting a menu using the mouse, or by double clicking the mouse button.

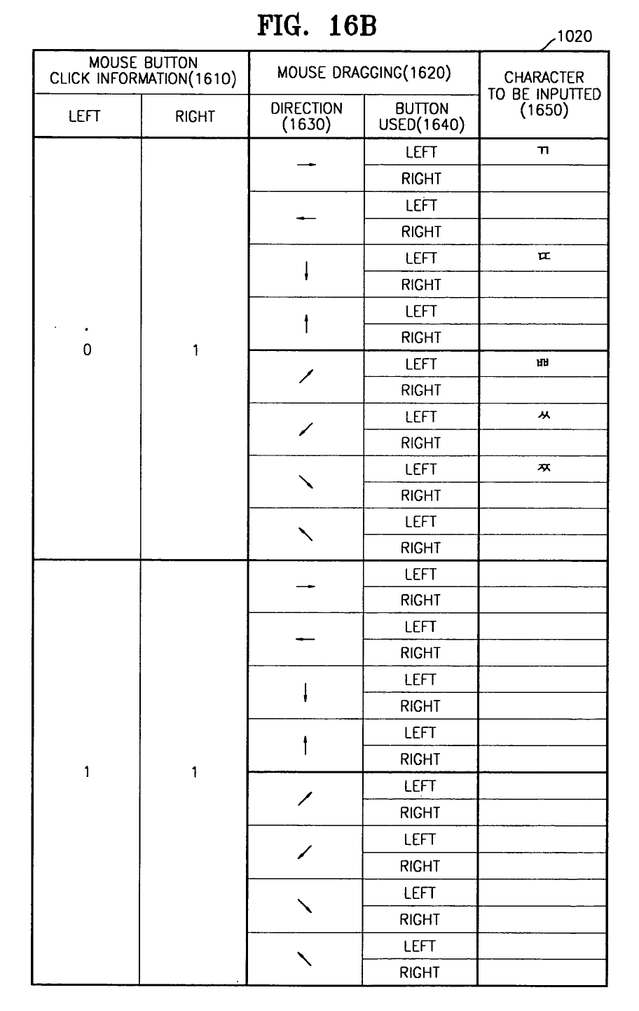

Characters corresponding to combinations of the mouse movements are stored in the character input table 270. The combinations of the information on a number of clicks of the mouse button, a number of double clicks of the mouse button, a movement direction of the mouse, the mouse button pressed while moving the mouse, or the like can be similarly applied, via a character input table corresponding to the characters to be inputted based on the information on the movements stored in the status flags. An example of character input tables is shown in FIGS. 15A through 17B.

The character selecting unit 260 receives the information stored in the mouse movement status storage unit 250 and refers to the character input table 270 in order to determine what characters the user desires to input by the current mouse movements. The character selected by the character selecting unit 260 is then transmitted to the display unit 220 through the output interface 280 and is displayed on a monitor.

The apparatus for inputting characters of FIG. 2 is configured to receive the information on the mouse movements, store it in the status flags, and select characters to be inputted using the stored information. However, it is well known to one skilled in the art that the character input table may be changed and searched whenever the information on the mouse movement is received, and that the character selected by the character selecting unit may be outputted to other applications.

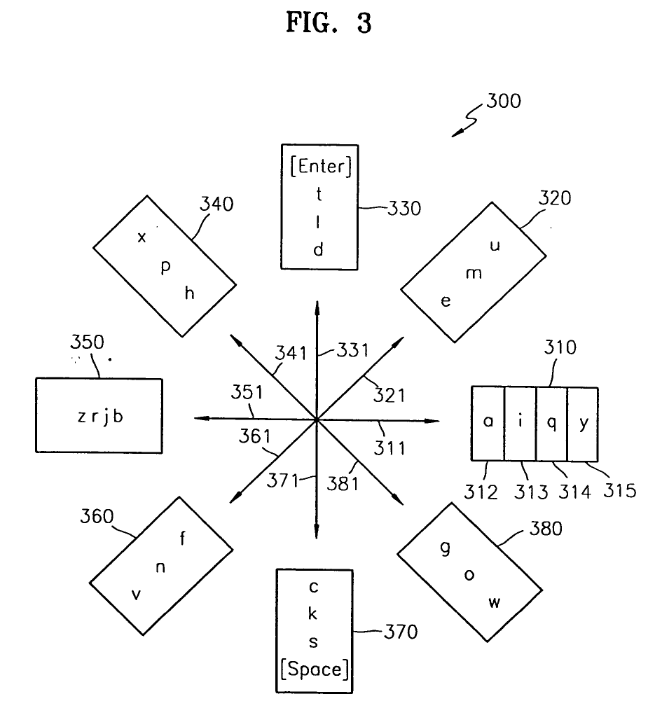

The user can see the interface, which shows what combination of the information on the mouse movements and the mouse button(s) clicked correspond to certain characters, e.g., any of the interfaces shown in FIGS. 3 through 8, on the display unit, and thus the user can select desired characters. However, if the user is familiar with such interface, the user can select desired characters without seeing the interface on the display unit.

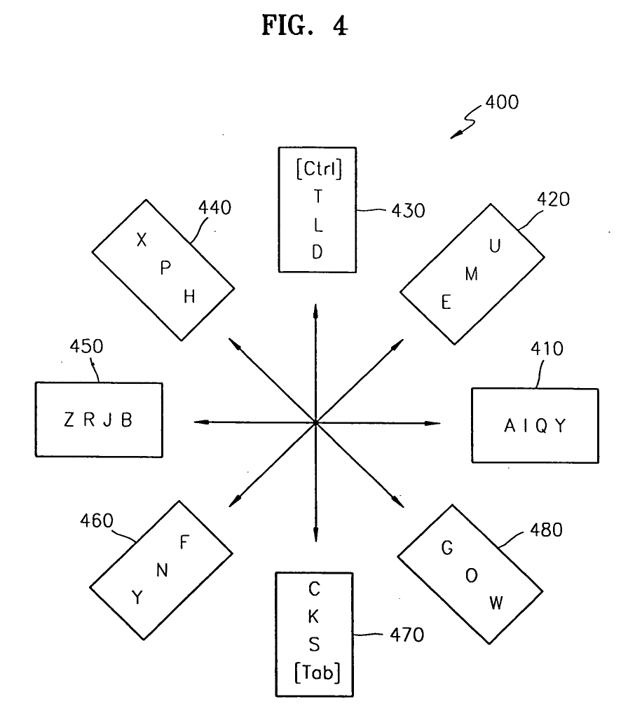

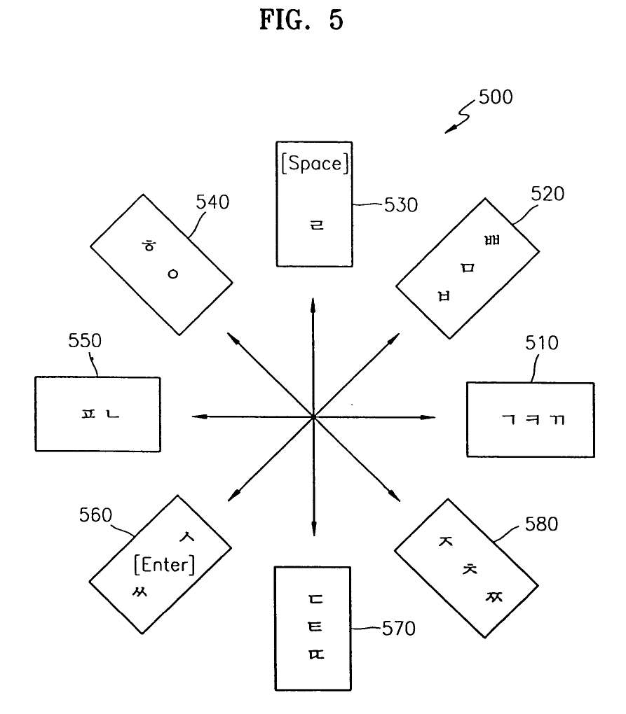

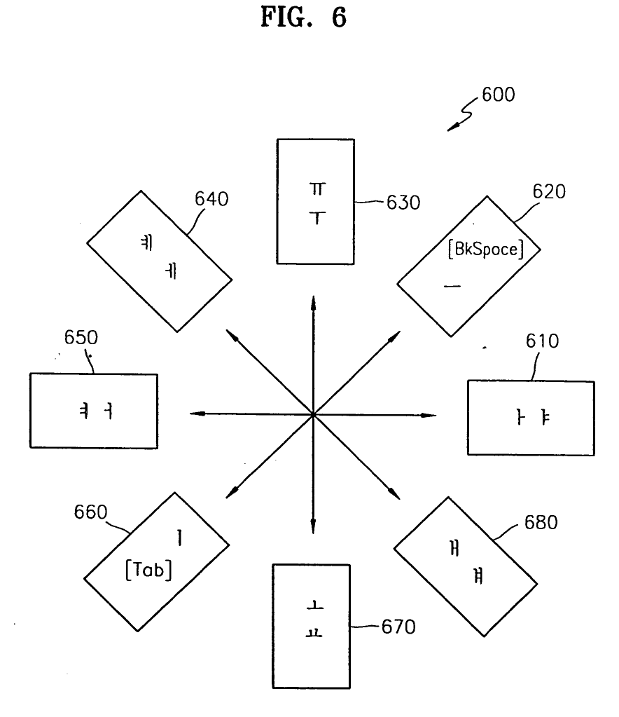

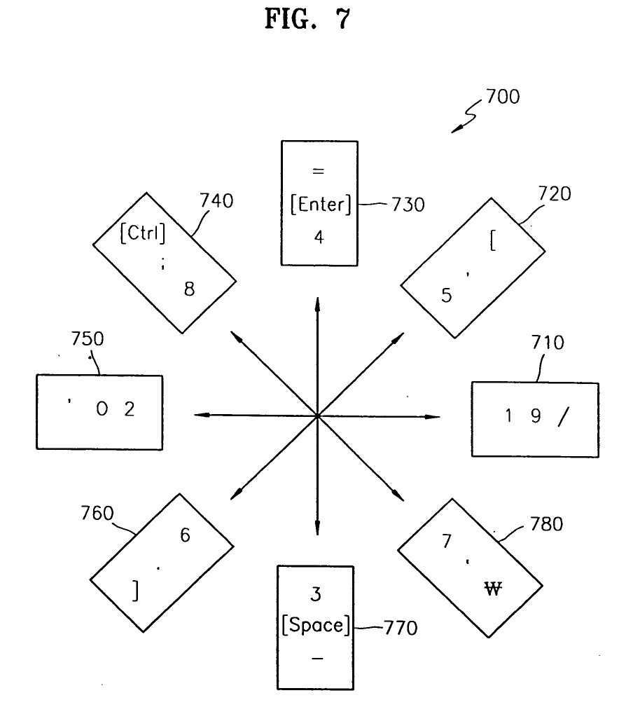

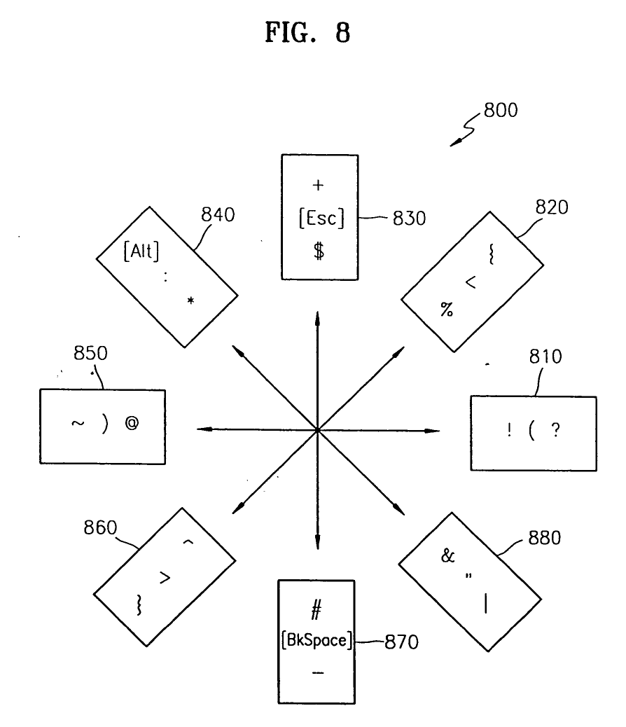

FIGS. 3 through 8 are conceptual views for describing the selection of characters by combinations of the mouse movement direction, the mouse button information on the mouse button which is held while moving the mouse and the mouse button click information corresponding to clicks of the mouse buttons, in each character input mode. FIGS. 3 and 4 show the English character input mode, FIGS. 5 and 6 show the Korean character input mode, and FIGS. 7 and 8 show the number keys and other keys input mode. A method of selecting such input modes will be described later.

FIG. 3 is a view for describing a method of inputting characters according to an exemplary embodiment of the present invention, in particular, after an English character input mode has been selected, in order to select a character, a left mouse button is clicked and the left mouse button is then pressed while moving the mouse.

The English characters shown in FIG. 3 can be typed by selecting the English input mode and pressing the left mouse button while moving the mouse.

Arrows 300 in eight directions from the central point indicate the directions in which the mouse moves. The eight directions can be E. 311, W. 351, S. 371, N. 331, NE. 321, NW. 341, SE. 381, and SW. 361. For example, the E. direction corresponds to moving the mouse to the right, the W. direction corresponds to moving the mouse to the left, etc.

Three or four characters can be selected in each direction, and one character can be typed by clicking the mouse button. For example, when the mouse moves in the direction of E. 311, one of four characters 310, i.e., “a” 312, “i” 313, “q” 314, and “y” 315 can be selected as follows: the character “a” 312 is selected by not clicking any mouse button, the character “i” 313 is selected by clicking the left mouse button, the character “q” 314 is selected by clicking the right mouse button, and the character “y” 315 is selected by clicking both the right and the left mouse buttons.

As described above, predetermined special keys as well as all of the English lowercase characters can be inputted by using the mouse click information when the English character input mode is selected and the left mouse button is pressed while moving the mouse.

FIG. 4 is a view for describing a method of inputting characters according to an exemplary embodiment of the present invention. In particular, after an English character input mode has been selected, in order to select a character, a right mouse button is clicked and the right mouse button is pressed while moving the mouse.

Similarly to FIG. 3, all of the English uppercase characters as well as various predetermined special keys can be inputted by using the mouse click information when the English character input mode is selected and the right mouse button pressed while moving the mouse. Furthermore, a caps lock key need not be pressed in order to enter these characters.

FIG. 5 is a view for describing a method of inputting characters according to an exemplary embodiment of the present invention. In particular, after a Korean character input mode has been selected, in order to select a character, a left mouse button is clicked and the left mouse button is pressed while moving the mouse.

Similarly to FIG. 3, the Korean consonants and predetermined special characters can be inputted by using the mouse click information when the Korean character input mode is selected and the left mouse button is pressed while moving the mouse.

FIG. 6 is a view showing a method of inputting characters according to an exemplary embodiment of the present invention. In particular, after a Korean character input mode has been selected, in order to select a character, a right mouse button is clicked and the right mouse button is pressed while moving the mouse.

Similarly to FIG. 3, the Korean vowels and predetermined special characters can be inputted by using the mouse click information when the Korean character input mode is selected and the right mouse button is pressed while moving the mouse.

FIG. 7 is a view for describing a method of inputting characters according to an exemplary embodiment of the present invention. In particular, after a number key and other character input mode has been selected, in order to select a character, a left mouse button is clicked and the left mouse button is pressed while moving the mouse.

Similarly to FIG. 3, the numbers and other characters can be inputted by using the mouse click information when the number and other key input mode is selected and the left mouse button is pressed while moving the mouse. The characters of FIG. 7 can be selected without pressing a shift key.

FIG. 8 is a view for describing a method of inputting characters according to an exemplary embodiment of the present invention. In particular, after a number key and other character input mode has been selected, in order to select a character, a right mouse button is clicked and the right mouse button is pressed while moving the mouse.

Similarly to FIG. 3, the numbers and other characters can be inputted by using the mouse click information when the number and other key input mode is selected and the right mouse button is pressed while moving the mouse. The characters of FIG. 8 can be selected without pressing a shift key.

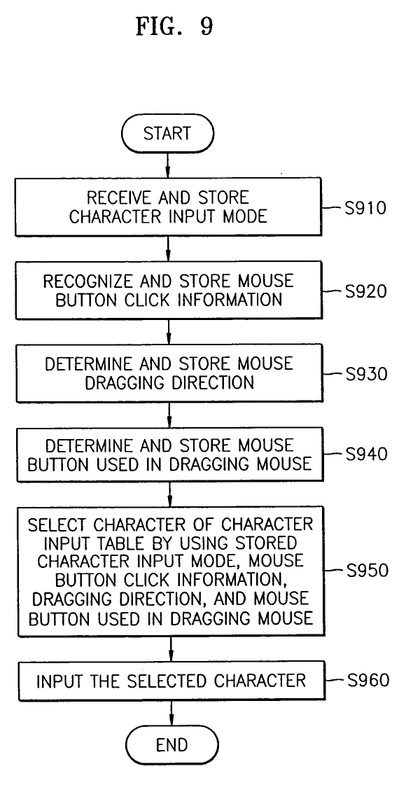

Hereinafter, the method for inputting characters will be described in detail with reference to FIGS. 9 through 14.

The character input mode is selected via the mouse movement recognizing unit 240 through the input interface 230 and is stored by the mouse movement status storage unit 250 (step S910).

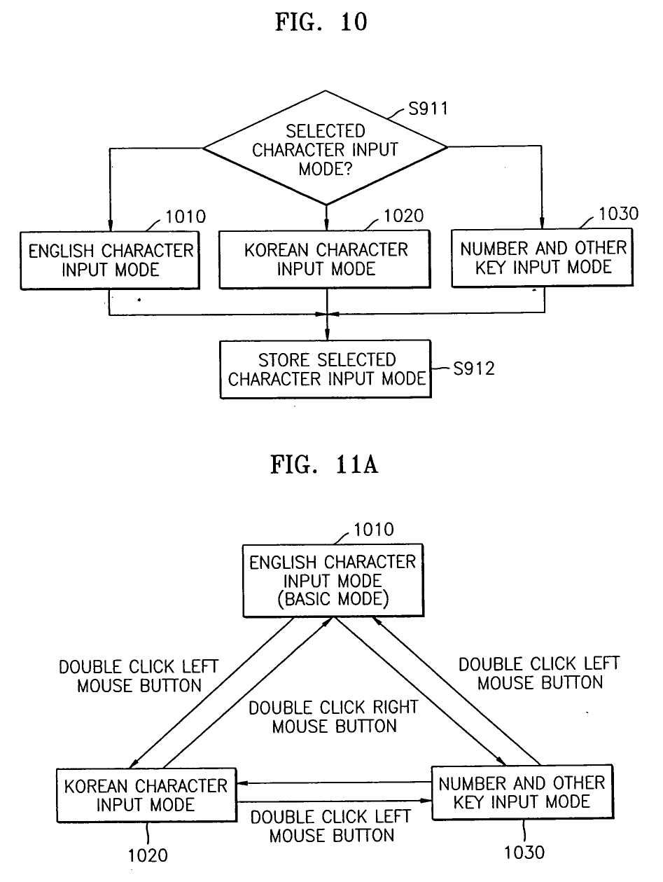

Step S910 is described in detail in FIG. 10, where it is determined what character input mode is selected by the user (step S911), and the determined character input mode is then stored (step S912).

Here, the character input modes include the English character input mode, the Korean character input mode, and a number and other key input mode. One of the three input modes can be selected through a menu on the monitor, which is displayed by using the user interface, or through the use of double clicks of the mouse button.

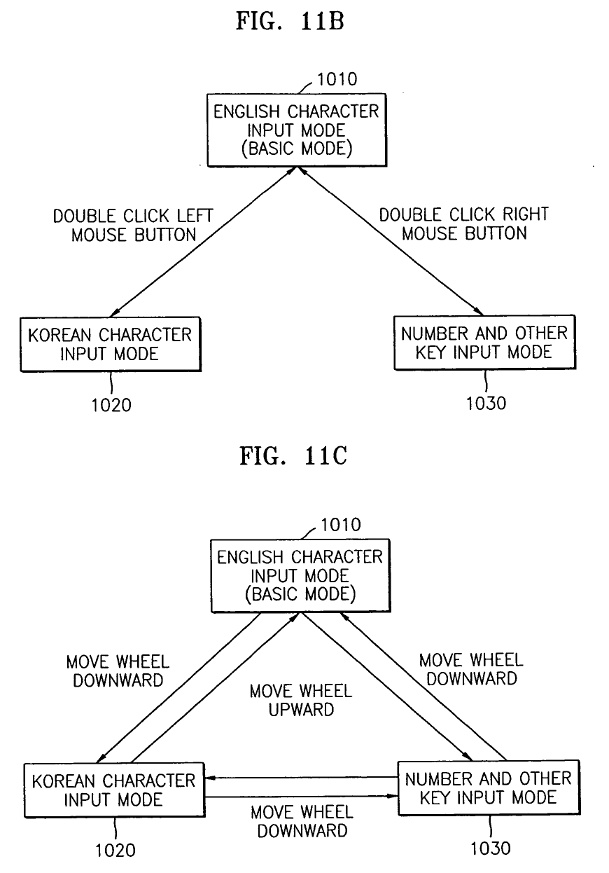

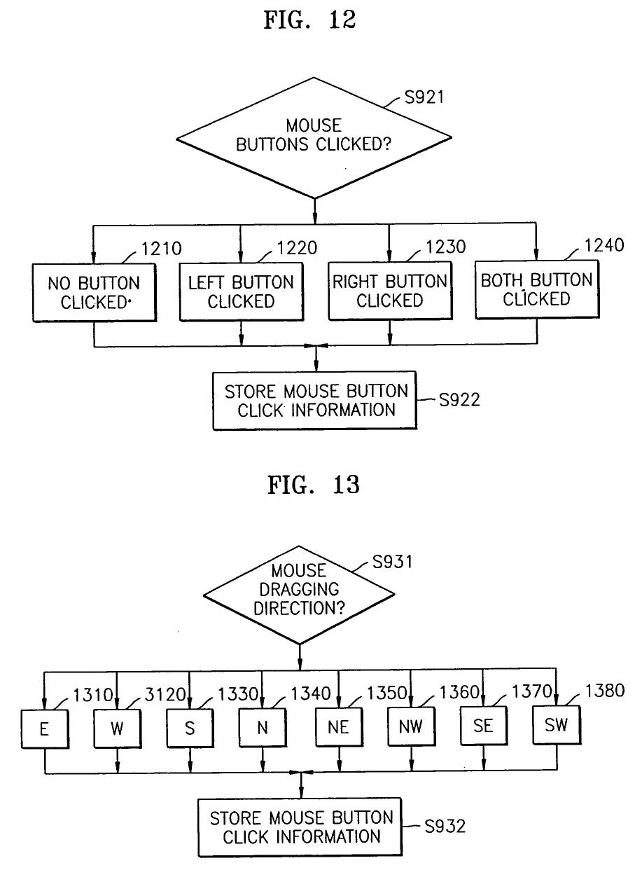

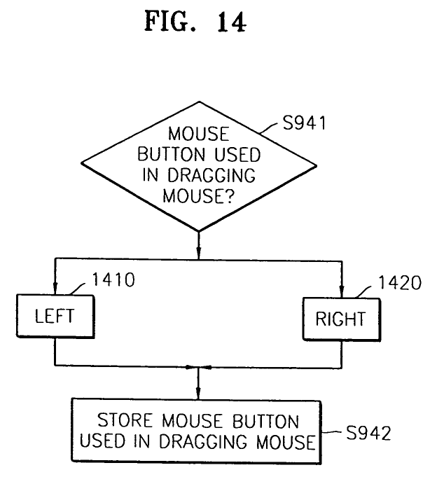

FIG. 11A is a view for explaining a first embodiment of a method of selecting a character input mode according to an exemplary embodiment of the present invention.

In FIG. 11A, an English character input mode 1010 is a basic mode, which is obtained by double clicking one of the mouse buttons. For example, the English character input mode 1010 can be changed into a Korean character input mode 1020 by double clicking the left mouse button, and the Korean character input mode 1020 can be changed into a number and other key input mode 1030 by double clicking the left mouse button once more. Here, the change of the character input mode means that the information on the character input mode changed by double clicking the mouse button is stored. It is obvious to one skilled in the art that the clicked mouse button can be the right mouse button.

FIG. 11B is a view for explaining a method of selecting a character input mode according to another exemplary embodiment of the present invention.

In FIG. 11B, the character input mode is changed by using both the left and the right mouse buttons. That is, the English character input mode 1010 is a basic mode, which can be changed to and from the Korean character input mode 1020 by double clicking the left mouse button and to and from the number and other key input mode 1030 by double clicking the right button.

FIG. 11C is a view for explaining a method of selecting a character input mode according to another exemplary embodiment of the present invention.

In FIG. 11C, the character input mode is changed by using a wheel mouse. The English character input mode 1010 is a basic mode, which can be changed into the Korean character input mode 1020 by moving the wheel mouse downward, into the number and other key input mode 1030 by moving the wheel mouse downward once more, and into the basic mode again by moving the wheel mouse downward again. Here, the character input mode can also be changed by moving the wheel mouse upward.

Next, the mouse button click information is recognized by the mouse movement recognizing unit 240 through the input interface 230 and stored by the mouse movement status storage unit 250 (step S920).

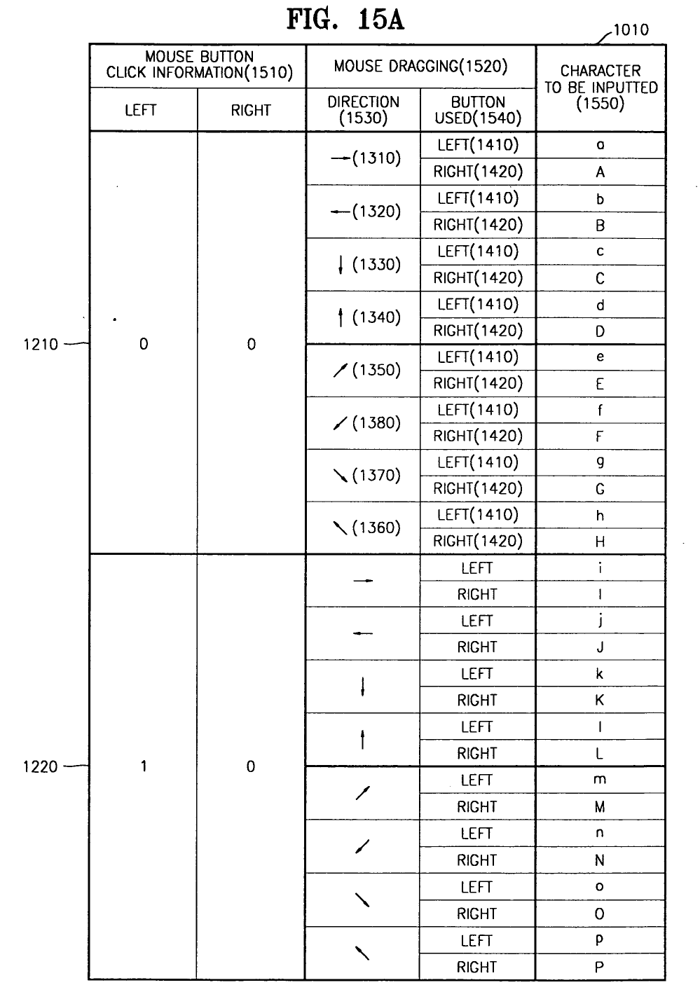

Step S920 is described in detail in FIG. 12. In step S920, the mouse button click information, which corresponds to the mouse button(s) which the user clicked, is determined (step S921), and the determined mouse button click information is then stored (step S922). The mouse button click information includes information on no button clicked 1210, a left button clicked 1220, a right button clicked 1230, and both buttons clicked 1240.

Next, the mouse dragging direction is recognized and stored (step S930).

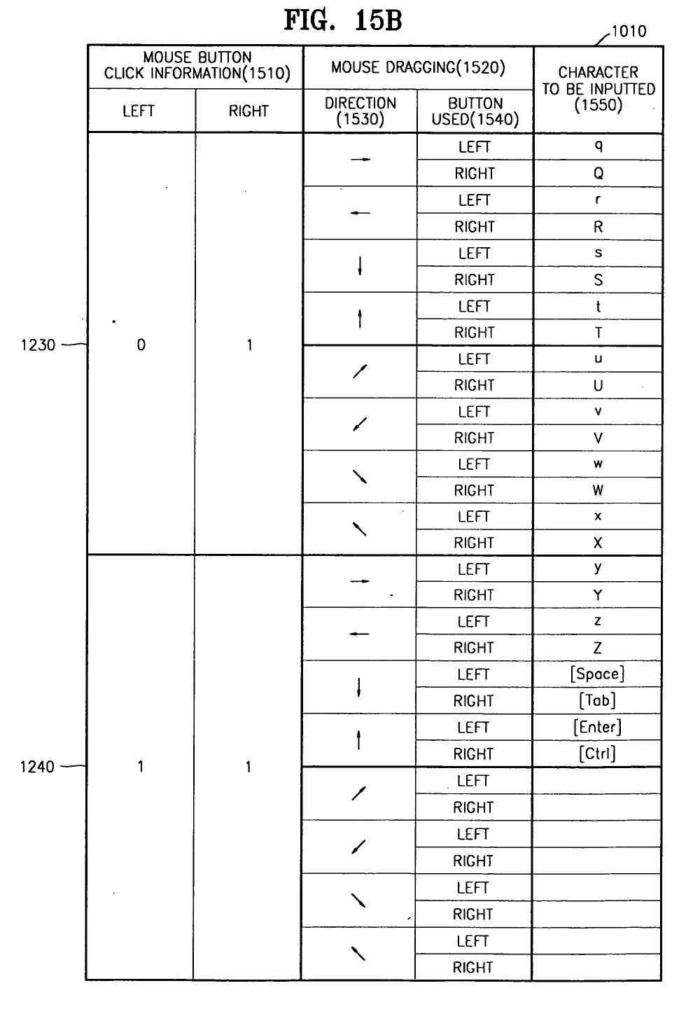

Step S930 is described in detail in FIG. 13. In step S930, the mouse dragging direction in which the user moves the mouse is determined (step S931), and the determined mouse movement direction is then stored (step S932). Recognized mouse dragging directions include, for example, the directions E. 1310, W. 1320, S. 1330, N. 1340, NE. 1350, NW. 1360, SE. 1370, and SW. 1380.

Next, information on the mouse button which is pressed while moving the mouse is determined and stored (step S940).

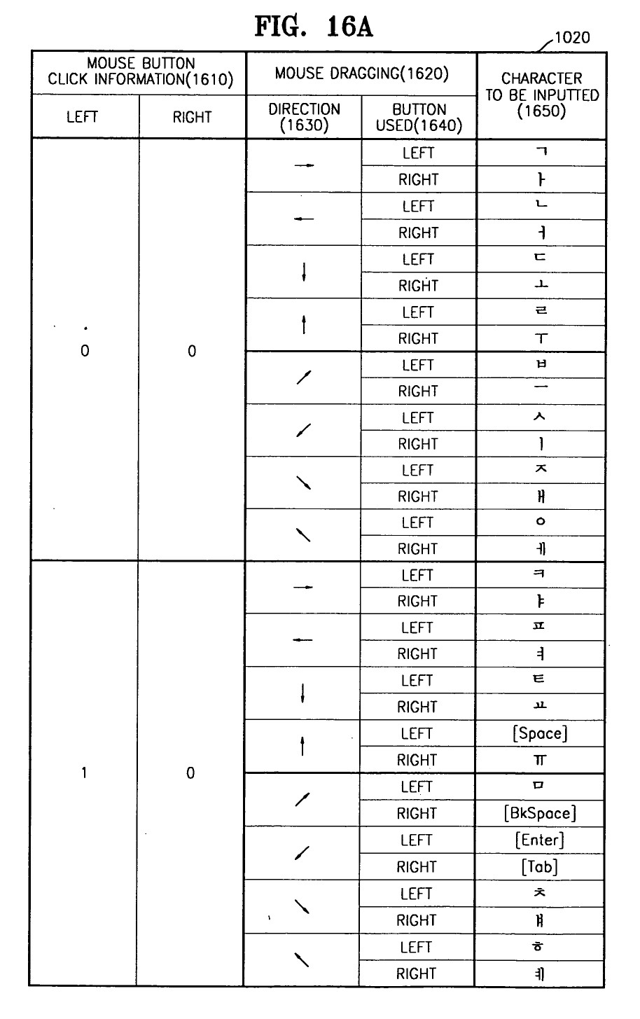

Step S940 is described in detail in FIG. 14. Here the mouse button which is held while moving the mouse is determined (step S941) and the determined mouse button information is then stored (step S942). The mouse button information includes information on a left mouse button 1410 and a right mouse button 1420.

Thus, the information on the mouse movements is stored in each status flag of the status storage unit 250 of FIG. 2.

Next, the characters to be inputted are selected from the character input table 270 by using the stored character input mode, the mouse button click information, the mouse movement direction, and the mouse button information on the mouse button which is held while moving the mouse (step S950). The character selecting unit 260 refers to the character input table 270 by using the status flags stored in the status storage unit 250, and thus the step S950 can be performed.

Character input tables 270 are illustrated in FIGS. 15A through 17B.

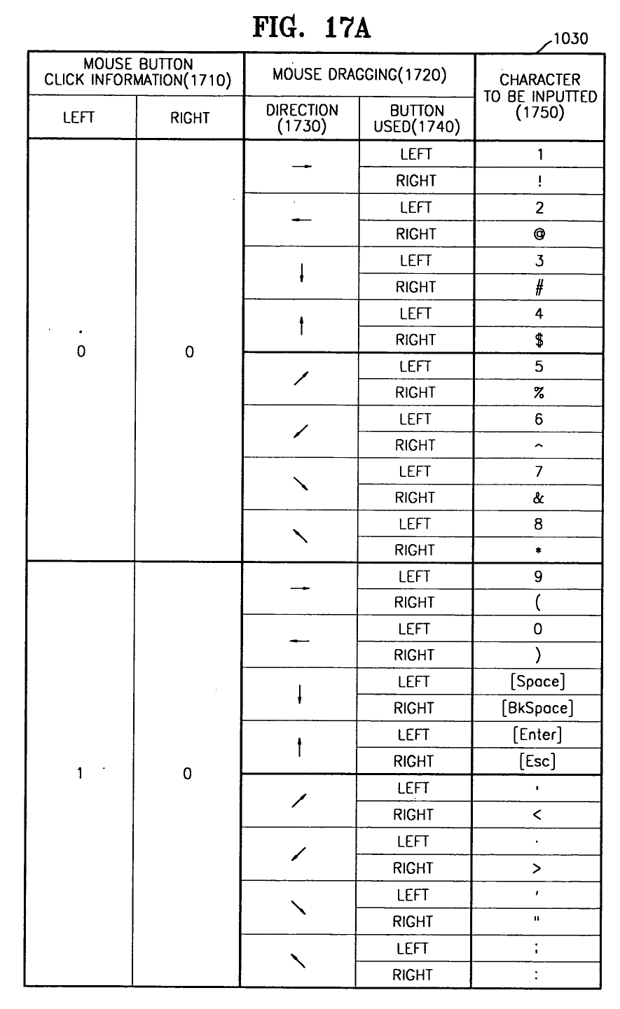

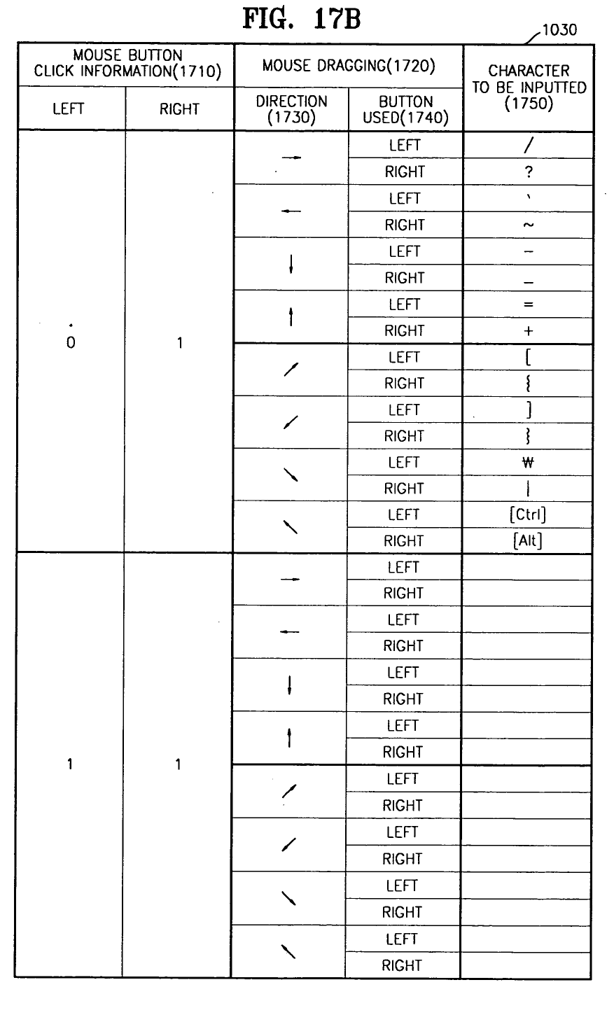

FIGS. 15A and 15B show the character input table of the English character input mode 1010. FIGS. 16A and 16B show the character input table of the Korean character input mode 1020. FIGS. 17A and 17B show the character input table of the number and other key input mode 1030.

A character input table corresponding to one of the English character input mode 1010, the Korean character input mode 1020, and the number and other key input mode 1030 is selected by using a character input mode value stored in the input mode status flag 251 of the mouse movement status storage unit 250.

Next, information on no button clicked 1210, left button clicked 1220, right button clicked 1230, or both buttons clicked 1240 of the mouse button click information 1510 stored in the status flag 252 is selected. In each character input table, information on no button clicked 1210 is presented as “00”, information on left button clicked 1220 is presented as “10”, information on right button clicked 1230 is presented as “01”, and information on both buttons clicked 1240 is presented as “11”.

For example, if the mouse click information “00” is selected from the character input table of the English character input mode 1010, one of E. 1310 (→), W. 1320 (←), S. 1330 (↓), N. 1340 (↑), NE. 1350 ( [symbol] ), NW. 1360 ( [symbol] ), SE. 1370 ( [symbol] ) and SW. 1380 ( [symbol] ) is selected by using mouse dragging direction information 1530 stored in a status flag 253.

For example, if E. 1310 (→) is selected as the mouse movement direction information, either the left 1410 or the right 1420 of the mouse button information stored in the status flag 254, which includes mouse button information 1540 on the mouse button which is pressed while moving the mouse, is selected, and then one character to be inputted is selected.

Next, the selected character to be inputted is inputted (step S960). For example, the selected character can be inputted in other applications or be outputted through the output interface to display on the displaying unit.

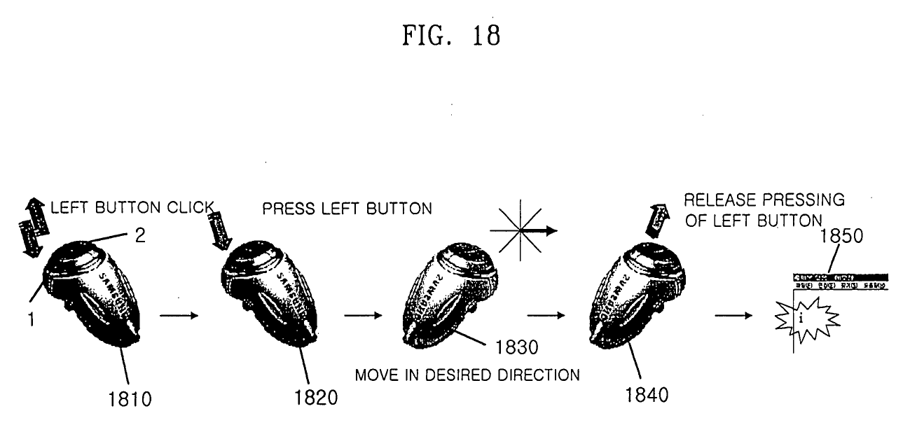

Now, a method of inputting characters according to an embodiment of the present invention will be described with reference to FIG. 18.

When the user desires to input character “i”, the English character input mode is first selected. The English character input mode can be selected by any of the methods presented with respect to FIGS. 11A through 11C. Then, a left mouse button 1 is clicked (step S1810), and the mouse is dragged toward east while pressing the left mouse button 1 (steps S1820 and S1830), and then the depressed left mouse button 1 is released (step S1840). As a result, the English lowercase letter “i” is inputted and displayed on a display (step S1850)

As another example, if the user desires to input the Korean group of characters “ [symbol] ”, the Korean character input mode 1020 is selected, a right mouse button (the button click information: right button clicked “01”) is clicked, and the mouse is dragged toward southwest (the direction information: SW. 1380) while pressing the left mouse button (the mouse button information: left 1410), and then after the left mouse button is released, the character “ [symbol] ” is inputted and displayed.

Then, the mouse is dragged toward east (the direction information: E. 1310) while pressing the right mouse button (the button information: right 1412). After the right mouse button is released, character “├” is inputted and displayed. Here, no mouse button was clicked, and thus the button click information is “00”. Next, the left mouse button is clicked (the button click information: left button clicked “10”), the mouse is dragged in a northwest direction (the direction information: NW. 1360) while pressing the left mouse button (the button information: left 1410). Then, after the left mouse button is released, character “ [symbol] ” is inputted and displayed.

According to the present invention, a character can be inputted via the mouse movement direction and the mouse button click information, and thus pointing and character inputting are possible by use of a conventional mouse. In addition, since only one hand is used to input characters the input device of the present invention is particularly useful for handicapped persons.

In addition, the characters can be inputted by using the information on the mouse movements and the mouse button click information, and thus it is not required to place the mouse on a plane surface. Therefore, the method of the present invention can be used for a portable keyboard.

While this invention has been particularly shown and described with reference to the above illustrative embodiments thereof, it will be understood by those skilled in the art that various changes in form and details may be made therein without departing from the spirit and scope of the invention as defined by the appended claims and equivalents thereof.

What is claimed is:

1. A method of inputting a character using a pointing device, the method comprising:
(a) recognizing information on a movement of the pointing device and a button click information of at least one button of the pointing device; and
(b) selecting a character by using the recognized information on a movement of the pointing device and the button click information of the at least one button of the pointing device.

2. The method of claim 1, wherein the information on a movement of the pointing device includes a movement direction in which the pointing device moves and information on a button which is pressed while the pointing device moves.

3. The method of claim 2, wherein recognizable movement directions include east, west, south, north, northeast, northwest, southeast, and southwest directions.

4. The method of claim 2, wherein two buttons are pressed when the pointing device moves.

5. The method of claim 1, wherein the button click information is information on the at least one button which is clicked before the pointing device starts to move.

6. The method of claim 5, wherein the button click information includes information on one of no button clicked, only a left button clicked, only a right button clicked, and both the left and the right buttons clicked.

7. The method of claim 1, wherein the method further comprises determining an inputted character input mode which corresponds to a type of character to be inputted.

8. The method of claim 7, wherein the character input mode includes one of an English character input mode, a Korean character input mode, and a number and other key input mode.

9. The method of claim 8, wherein the determining of the inputted character input mode is performed using information on a double-click of at least one button of the pointing device.

10. The method of claim 9, wherein the determining of the inputted character input mode includes rotating the character input mode into one of the English character input mode, the Korean character input mode, and the number and other key input mode using the number of double-clicks of the at least one button.

11. The method of claim 10, wherein the direction of rotation between the character input modes differs when a left button of the pointing device is double-clicked and when a right button of the pointing device is double-clicked.

12. An apparatus for inputting a character using a pointing device, the apparatus comprising:
a character input table which stores combinations of information on movements of the pointing device and button click information of at least one button of the pointing device and maps the combinations to characters to be inputted;
a movement recognizing unit which recognizes the information on the movements of the pointing device and the button click information of the at least one button of the pointing device;
a status storage unit which stores the recognized information on the movements of the pointing device and the recognized button click information; and
a character selecting unit which selects a character that corresponds to the information on the movements of the pointing device and the button click information, which are stored in the status storage unit, by referring to the character input table.

13. The apparatus of claim 12, wherein the status storage unit comprises:
a first status flag which stores double-click information of the at least one button of the pointing device;
a second status flag which stores the button click information of the at least one button of the pointing device;
a third status flag which stores a movement direction of the pointing device; and
a fourth status flag which stores information on the at least one button which is pressed while the pointing device moves.

14. The apparatus of claim 13, wherein the double-click information which is stored in the first status flag determines a character input mode, and a combination of the information which is stored in the second status flag, the third status flag and the fourth status flag determines the character based on the determined character input mode.

15. The apparatus of claim 12, wherein the character input table includes one of a character input table of an English character input mode, a Korean character input mode, and a number and other key input mode.

16. The apparatus of claim 15, wherein each character input table is configured to map a combination of the button click information, the movement direction of the pointing device, and the information on the at least one button which is pressed while the pointing device moves to a character to be inputted.

17. The apparatus of claim 16, wherein, in the character input tables of the English character input mode and the number and other key input mode, information on a left button of the pointing device, which is pressed when the pointing device moves, determines characters corresponding to characters of keys of a standard keyboard without a “shift” key being pressed, and information on a right button of the pointing device, which is pressed when the pointing device moves, determines characters corresponding to characters of keys of the standard keyboard having the “shift” key pressed.

18. The apparatus of claim 16, wherein, in the character input table of the Korean character input mode, information on a left button of the pointing device, which is pressed when the pointing device moves, determines characters corresponding to consonant keys of a standard keyboard, and information on a right button of the pointing device, which is used when the pointing device moves, determines vowel keys of the standard keyboard.

19. The apparatus of claim 12, wherein the pointing device is a mouse having a plurality of buttons.

20. The apparatus of claim 19, wherein the mouse is a wheel mouse.
